(19) United States
(12) Patent Application Publication
(10) Pub. No.: US 2024/0333212 A1
(43) Pub. Date: Oct. 3, 2024

(54) SUPERCAPACITOR-IMPLEMENTED SOLAR CELL WITH INTEGRATED PHOTOVOLTAICS AND ENERGY STORAGE

(71) Applicant: Ask Solar LLC, Galveston, TX (US)

(72) Inventors: Sumedha Reddy KATAKAM, Frisco, TX (US); Keshav NARANG, Fremont, CA (US); Andrew Glen MULLIKIN, Galveston, TX (US)

(21) Appl. No.: 18/624,098

(22) Filed: Apr. 1, 2024

Related U.S. Application Data
(60) Provisional application No. 63/456,519, filed on Apr. 2, 2023.

(51) Int. Cl. H02S 40/38; H02J 7/34; H02J 7/35

(52) U.S. Cl. CPC H02S 40/38; H02J 7/345; H02J 7/35

(57) ABSTRACT

An integrated apparatus for generating and storing electricity is described, including one or more photovoltaic electricity generators, one or more supercapacitors, and one or more electrical connections. The one or more supercapacitors are configured to be selectively electrically connected to the one or more photovoltaic electricity generators for electrical charge storage and electrical discharge.

### CROSS-REFERENCE TO RELATED APPLICATIONS

This application claims the benefit of U.S. Patent Application Ser. No. 63/456,519 filed Apr. 2, 2023, entitled, “PEROVSKITE AND QUASI-SOLID ELECTROLYTE-BASED SUPERCAPACITOR-IMPLEMENTED SOLAR CELL FOR INTEGRATED PHOTOVOLTAICS AND ENERGY STORAGE,” which application is incorporated herein in its entirety.

### FIELD

The present disclosure relates generally to generating and storing energy, and more specifically to methods and apparatuses for generating and storing electricity from light sources.

### BACKGROUND

Nonrenewable energy sources are not sustainable and cause or contribute to a plethora of negative environmental effects. Thus, it would be desirable to better harness renewable energy sources. To elaborate, renewable energy is increasingly desirable for all manner of uses and both the public and private sector have been investigating options for rapid and large-scale adoption of such renewable energy solutions. Solar energy is one form of renewable energy that harnesses the power of one of the most common and widely available resources, sunlight. Solar panels are one way in which solar energy can be captured and converted or used to generate electrical energy. Since solar energy is widely available, solar energy is considered to be a resource with high renewable potential and vast applicability.

However, while capturing solar energy and using it to generate electricity that can be stored and put to productive use may initially appear straightforward, the process can be complicated. In particular, conversion of solar energy in the form of photonic or light energy into electricity and the storage of such electricity can be affected by many unpredictable factors. For example, solar energy capture and conversion to electricity can be unreliable due to the variability of sunlight, such as differences in solar energy based on the time of day, weather (e.g., cloud cover), and physical factors based on location, such as shadows. Conversion of energy from photonic energy to electrical energy and from electrical energy to chemical energy that is stored in batteries can also suffer from losses. Furthermore, batteries that store harvested solar energy also suffer from a number of problems. Traditional batteries that have been used to store solar energy can have high costs (e.g., averaging $10,000 or more), may be heavy (e.g., weighing over 200 pounds each), and may be produced in dirty manufacturing processes, such as strip mining. Thus, such batters can be generally unaffordable, bulky, and environmentally unfriendly.

Problems exist at every stage of the solar power capture and storage cycle. High-performance solar panels capturing solar energy can currently reach an efficiency of 23% energy conversion. Compared to the average coal power plant efficiency of 33% energy conversion, this efficiency is inadequate for a large portion of residential energy consumers. Furthermore, in most instances, batteries that are used to store harvested solar energy are not located in close proximity to the solar panels used in the harvesting operation. This physical separation between solar panels and external batteries is inefficient and when combined with the energy losses of typical batteries, especially those including lithium, transmission losses of as much as 20% of energy generated are common. Existing solar batteries may be lead-acid batteries, which can be discharged at a maximum of about 50%, or lithium-ion batteries, which can be discharged at a maximum of about 80%. With these limited discharge rates, solar energy batteries fail to provide adequate and efficient storage solutions.

Not only is energy conversion, transmission, and storage a problem, but grid instability is a growing concern. Stability in local, regional, and national power grids is an increasingly important consideration, and such concern now extends down as far as individual residential energy systems. In the modern era of intensive energy use, global energy use is increasing 1% to 2% annually and individual residential solar energy capture solutions that help to maintain grid stability are highly desirable. However, current battery and installation costs can reach $16,000 per residence, a hefty investment. Furthermore, despite the desirability of existing individual solar energy capture and storage solutions, the additional units connected to the grid increase the footprint of the energy system significantly, and the required annual maintenance.

The exploration of new solar energy capture and storage systems is necessary if adoption of solar power solutions is to become commonplace, economically and physically feasible, and even preferred efficiency-wise over nonrenewable energy sources that are in common use currently.

### SUMMARY

Disclosed herein are solutions that integrate solar energy capture, conversion, and storage.

In an example, the aspects include an integrated apparatus for generating and storing electricity, with one or more photovoltaic electricity generators and one or more supercapacitors. Additionally, these aspects include the one or more supercapacitors are configured to be deposited on the one or more photovoltaic electricity generators for electrical charge storage and electrical discharge.

In another example, the aspects include a method of generating and storing electricity using an integrated solar cell by generating electrical charge via one or more photovoltaic electricity generators, selectively allowing electrical flow to one or more supercapacitors, and storing the generated electrical charge via one or more supercapacitors.

To accomplish the foregoing and related ends, one or more aspects comprising features that are fully described and particularly pointed out in the claims. The following description and the annexed drawings set forth in detail certain illustrative features of the one or more aspects. These features are indicative of some of the various ways in which the various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1A is a perspective view of an apparatus for converting and storing photonic energy as electrical energy;

FIG. 1B is a side view of an apparatus for converting and storing photonic energy as electrical energy;

FIG. 1C is a side view of an apparatus for converting and storing photonic energy as electrical energy;

FIG. 1D is a side view of an apparatus for converting and storing photonic energy as electrical energy including;

FIG. 1E is a top view, shown partly in phantom, of an apparatus for converting and storing photonic energy as electrical energy;

FIG. 2A is a side view, shown partly in phantom, of the apparatus for converting and storing photonic energy as electrical energy in an initial state;

FIG. 2B is a side view, shown partly in phantom, of the apparatus for converting and storing photonic energy as electrical energy in a second state;

FIG. 2C is a side view, shown partly in phantom, of the apparatus for converting and storing photonic energy as electrical energy in a third state;

FIG. 3 is a diagram showing the apparatus for converting and storing photonic energy as electrical energy in different states; and

FIG. 4 is a flow diagram illustrating a method in accordance with an aspect of the present disclosure.

FIG. 5 shows a perspective view of an example apparatus for converting and storing photonic energy as electrical energy according to aspects herein.

FIG. 6 shows a chart of supercapacitor materials and characteristics.

FIG. 7 shows a number of charts for supercapacitor performance characteristics.

FIG. 8 shows a chart of supercapacitor design and data.

### DETAILED DESCRIPTION

Various aspects are now described with reference to the figures. In the following description, numerous specific details are set forth in order to provide a thorough understanding of one or more aspects of the various innovative systems and methods. It may be evident, however, that such aspect(s) may be practiced without these specific details or features or with different combinations thereof.

It will be readily understood that the components of the aspects as generally described herein and illustrated in the figures could be arranged and designed in a wide variety of different configurations. Thus, the following detailed description of various aspects illustrated in the figures is not intended to limit the scope of the present disclosure, but is merely representative of various aspects. While various aspects of the disclosure are presented in drawings, the drawings are not necessarily drawn to scale unless specifically indicated.

The present aspects may be embodied in other specific forms without departing from its spirit or essential characteristics. The described aspects are to be considered in all respects only as illustrative and not restrictive. The scope of the innovation is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present innovation should be or are in any single aspect of the innovation. Rather, language referring to the features and advantages is understood to mean that a specific feature, advantage, or characteristic described in connection with an aspect is included in at least one aspect of the present innovation. Thus, discussions of the features and advantages, and similar language, throughout the specification may, but do not necessarily, refer to the same aspect.

Furthermore, the described features, advantages and characteristics of the present disclosure may be combined in any suitable manner in one or more aspects. One skilled in the relevant art will recognize, in light of the description herein, that the disclosure can be practiced without one or more of the specific features or advantages of a particular aspect. In other instances, additional features and advantages may be recognized in certain aspects that may not be present in all aspects of the disclosure.

Reference throughout this specification to “one aspect,” “an aspect,” or similar language means that a particular feature, structure, or characteristic described in connection with the indicated aspect is included in at least one aspect of the present disclosure. Thus, the phrases “in one aspect,” “in an aspect,” and similar language throughout this specification may, but do not necessarily, all refer to the same aspect.

As used in this document, the singular form “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

In some aspects, direct integration of a silicon solar cell with thiol-functionalized nitrogen-incorporated reduced graphene-oxide nanoscroll supercapacitors with solar panels can be performed or accomplished in order to create a solar panel and supercapacitor system and/or apparatus that, in a single unit, both collects and stores energy. In general, this can include two primary components: a nitrogen-incorporated thiol-functionalized reduced graphene oxide scroll supercapacitor (NTGS) and a silicon solar cell. NTGS can offer a high power density (e.g., 496 W/kg) and a high energy density (e.g., 206 Wh/kg) at a current density (e.g., 0.25 A/g). This arrangement can result in a rapid discharge and recharge rate necessary for directly integrated energy storage. NTGS can provide enhanced performance over various supercapacitor electrode materials in terms of energy density, which is crucial in maintaining a manageable energy storage section thickness. For example, a vanadium sulfide/reduced graphene oxide electrode may fall short at an energy density of 117 Wh/kg. The NTGS's remarkably high energy density enables an energy storage compartment on a 1 square meter panel to store energy for the needs of a day while requiring only a small amount of physical space (e.g., 2.032 centimeters in thickness). This can enhance utility installment regulation compliance. Additionally, NTGS can provide a long cycle life that is absent in lithium-ion battery solutions with numerous and frequent cycles. This cycle life can include a great amount of capacitance retention after many cycles (e.g., 88% capacitance retention after 20,000 cycles). Through DC power, direct supercapacitor integration enables adaptive switching between storing and directly utilizing energy without energy losses incurred by using a solar inverter or the need for external electrical circuits.

Aspects included herein allow for the direct integration of one or more perovskite solar cells, for light absorption and conversion to electrical energy and supercapacitors, highly-efficient electrical energy storage mechanisms, for storing converted solar energy. Such charging from a luminescent source or sources (e.g., from the sun) and discharging can be controlled via manipulation of electrical pathways and external circuits that couple or connect or decouple or disconnect electrodes in the cell. Working mechanisms for the cell can include competitive areal capacitance of WO₃, as compared to other materials with similar capacitance properties. Thus, tungsten trioxide and/or other high-capacitance materials with similar properties can be used. Tungsten trioxide, in particular, when combined with titanium dioxide, receives an increased charge accommodation ability of about 250%. Thus, when these metal oxides are incorporated into a nanotube structure, the efficiency of charge conservation can be highly enhanced.

Systems and apparatuses herein can incorporate a co-cathode structure, where a single section acts as both the cathode of the perovskite solar cell section and the electrochromic supercapacitor section, in order to allow for direct connection of photovoltaics and energy storage. Electrochromic in some aspects can mean that the supercapacitor conveniently displays visible indications of changes in charge states through color changes that are perceived by the human eye. Integration of charging and storage is achieved in some aspects through a conductive mid-glass that electrically connects the two sub-systems of charging and storage. The integrated solar cell's discharge and recharge cycles enable the cells to be useful in both light and dark, whereby charging and use can occur when the sun is out and stored charge can be used when the sun is not out.

Aspects include integrating energy storage and photovoltaics using a vertically-stacked photovoltachromic supercapacitor (PVCS) structure. An integrated apparatus includes two main components: an electrochromic supercapacitor (ECS) (e.g., with TiO₂/WO₃ nanotubes) and a semi-transparent perovskite solar cell (PSC). Perovskite is used due to its plentiful benefits, including a maximum theoretical fill-factor, a measure of efficiency of 90.5% in solar cell. Additionally, perovskite has a unique structure, allowing for the development of a diverse range of engineered materials, so its applications are immense. Perovskite can be cheaply produced, can function efficiently even with imperfections, has a much faster improvement of efficiency rate that prior used materials, and is lightweight. Additionally, perovskite is easily recyclable, while lithium, which is what is typically used in solar batteries, is very difficult to recycle.

In some aspects, in order to mitigate the degradation of perovskite, a supercapacitor (e.g., TiO₂/WO₃ nanotube) can be placed on top of the perovskite solar cell. Perovskite degrades due to direct sun exposure, and by significantly reducing the surface area of the perovskite solar cell section exposed to sunlight through the placement of the TiO₂/WO₃ supercapacitor directly above it, degradation is minimized and photostability is maximized. This is particularly effective under the fully-charged state of the electrochromic supercapacitor due to the color change to a bleached state that reflects thermal radiation and absorbs sunlight.

In some aspects, the layers in a solar cell are as follows: 20 nm of glass, 20 nm of fluorine doped tin oxide (FTO), TiO₂/WO₃, Au (i.e., gold), and perovskite nanotubes 100 nm long. The Au and perovskite act as plasmonic materials and absorb hot electrons, which are a common culprit for waste heat in perovskite solar cells. A combination of poly vinyl alcohol (PVA), sulfuric acid (H₂SO₄), and alizarin red S (ARS) to produce a particularly effective quasi-solid electrolyte avoiding the leakage complications of fully liquid electrolytes 300 nm long, TiO₂/WO₃, Au, and perovskite nanotubes 100 nm long, fluorine doped tin oxide spanning a height of 20 nm, a mid-layer of glass of 20 nm, another 20 nm layer of FTO, TiO₂/WO₃, Au, and perovskite nanotubes 100 nm long again, perovskite 100 nm long, spiro-OMeTAD for the hole-transporting layer (HTL) spanning 200 nm, 15 nm of molybdenum oxide for a PVS electrode, 12 nm of an Au layer, and yet another layer of molybdenum oxide. The entire system, PSC and ECS combined, is enclosed in a translucent thin glass-walled chamber 20 nm thick. To form a co-cathode structure, a mid-glass electrically connects the ESC and PCS sections. The FTO on both sides of the glass serve as the cathode for its respective section. The WO₃ electrode in the TiO₂/WO₃ nanotube system serves as the anode of the ECS and the Au sandwiched by molybdenum oxide layers (the MAM electrode) structure serves as the anode of the PCS section. When the overall system reaches its fully charged state, the ECS section turns blue, with the W changing from a bleaching to coloring state.

The nanotubes structure is used for the electrodes and electron transfer because nanotubes have desirable electron transfer properties and are proven efficient electrodes in a system relying solely on a WO₃ portion. Additionally, nanotubes simplify the manufacturing process and improves the incident photon to electrical current efficiencies of both WO₃ and TiO₂ through effective combination. Nanotubes require the cheap process of anodization using foil.

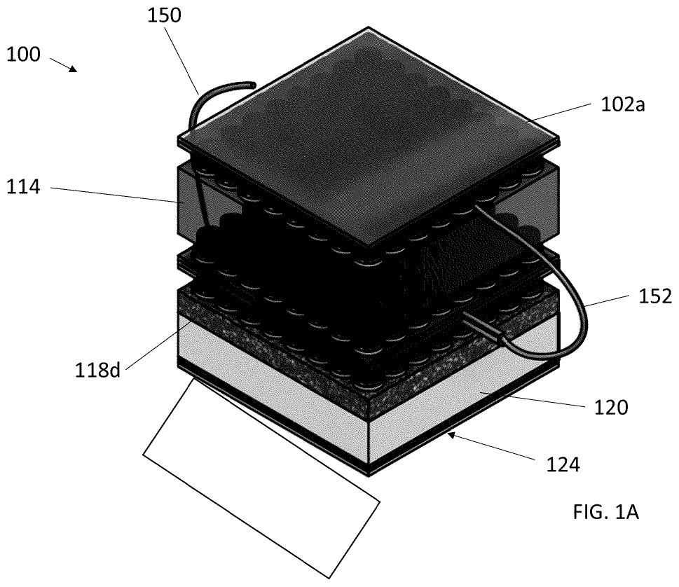

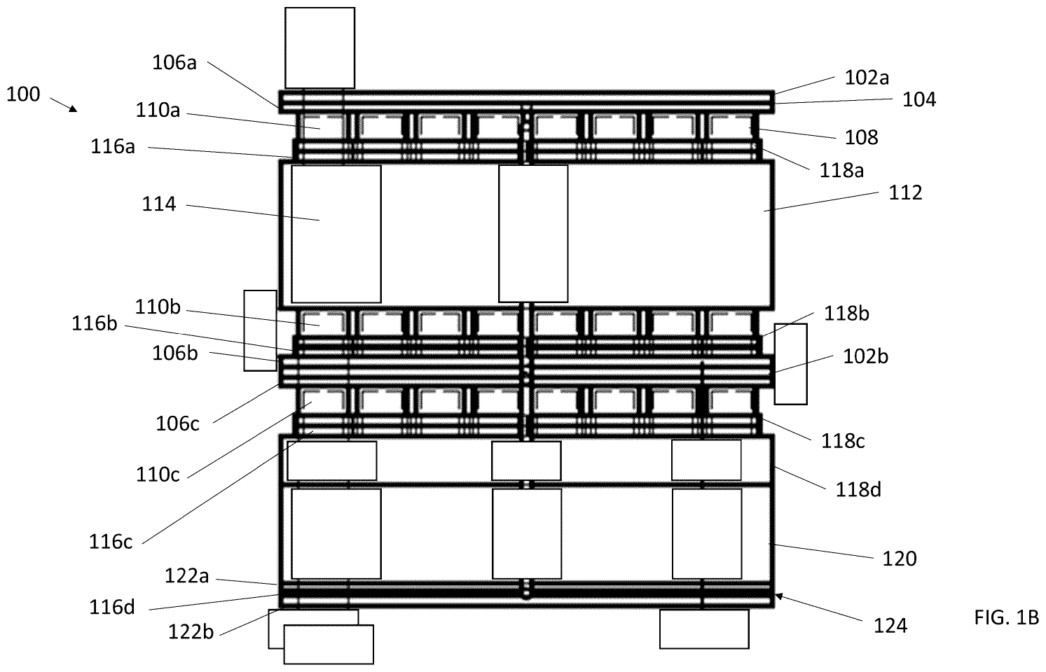

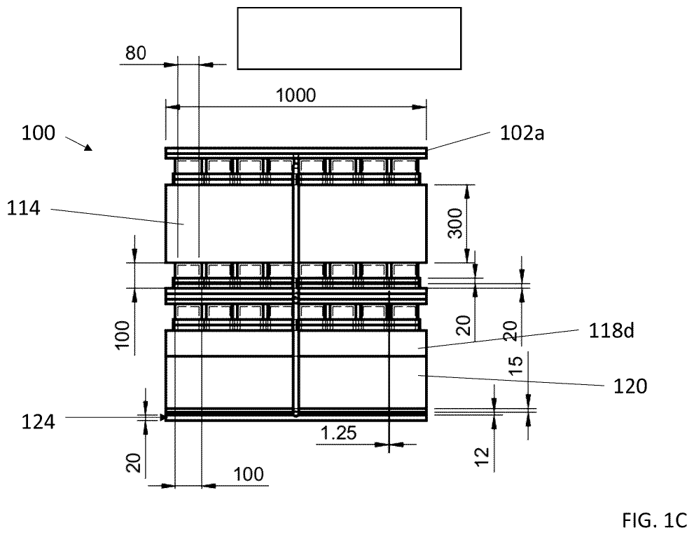

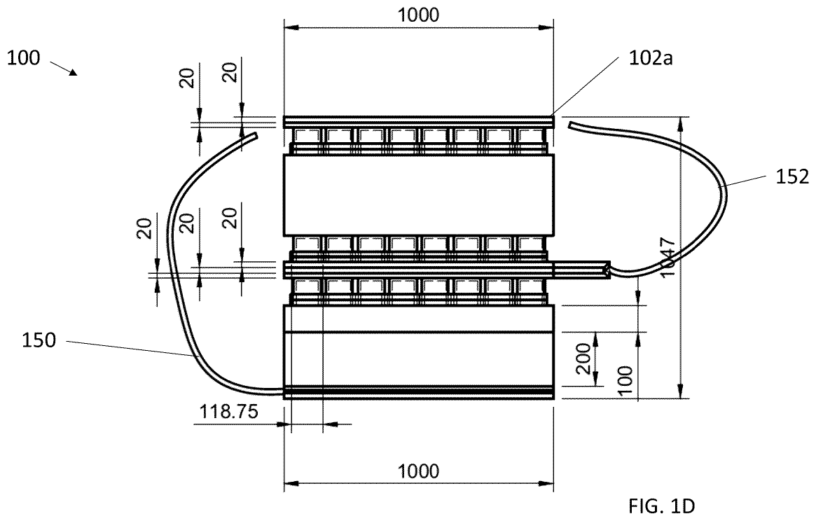

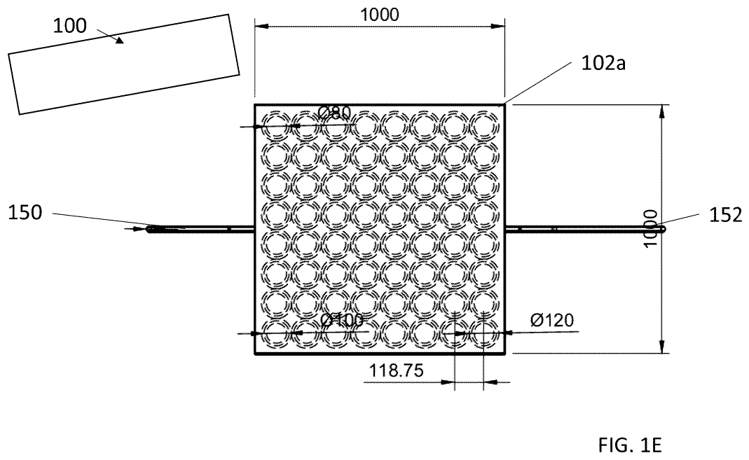

Referring now to the figures and the apparatuses disclosed therein, FIGS. 1A-1E show various views of an apparatus for converting and storing photonic energy as electrical energy according to aspects herein. FIG. 1A is a perspective view; FIG. 1B is a side view; FIG. 1C is a side view; FIG. 1D is a side view; and FIG. 1E is a top view, shown partly in phantom, of an apparatus for converting and storing photonic energy as electrical energy.

Various layers of materials, components, and/or elements may be arranged in different fashions and orientations in order to create functional apparatuses and systems and achieve the methods disclosed in different aspects. Layers include an upper layer 102a of glass, over a layer 104 of transparent conductive oxide. Next a layer 106a of fluorine doped tin oxide, over an electrode layer 108 that can include TiO₂/WO₃ nanotubes 110a. A layer 118a of perovskite can then be included over a layer 116a of gold. Next, a layer 114 can include PVA+H2SO4+ARS and can be a quasi-solid electrolyte 112. Another layer 110b of TiO₂/WO₃ nanotubes can follow, over a layer 118b of perovskite, over a layer 116b of gold, and then a layer 106b of fluorine doped tin oxide that is separated by a layer 102b of glass from another layer 106c fluorine doped tin oxide. A layer 110c of TiO₂/WO₃ nanotubes can be over a layer 118c of perovskite, which can be over a layer 116c of gold, which can be over another layer 118d of perovskite. Layer 120 can be Spiro-OMeTAD, which can be over a layer 122a of MoO2, a layer of gold 116d, and a layer 122b of MoO2. Layers 122a, 116d and 122b can be referred to collective as a MAM electrode 124 (i.e., MoO2, Au, MoO2). A first electrical pathway 150 can be coupled with the MAM electrode 124 and selectively coupled with the transparent conductive oxide layer 104. An external circuit 152 can be connected to allow discharge of the charged PVCS.

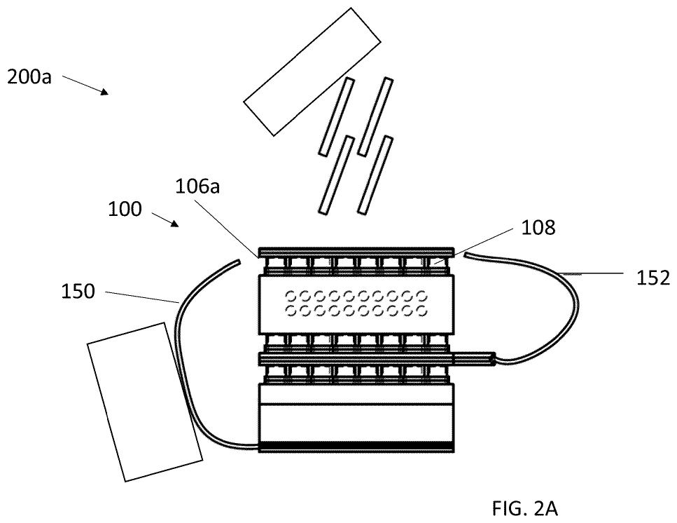

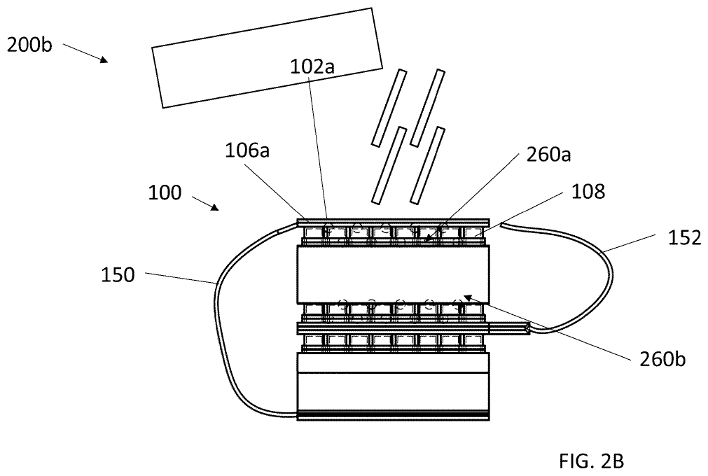

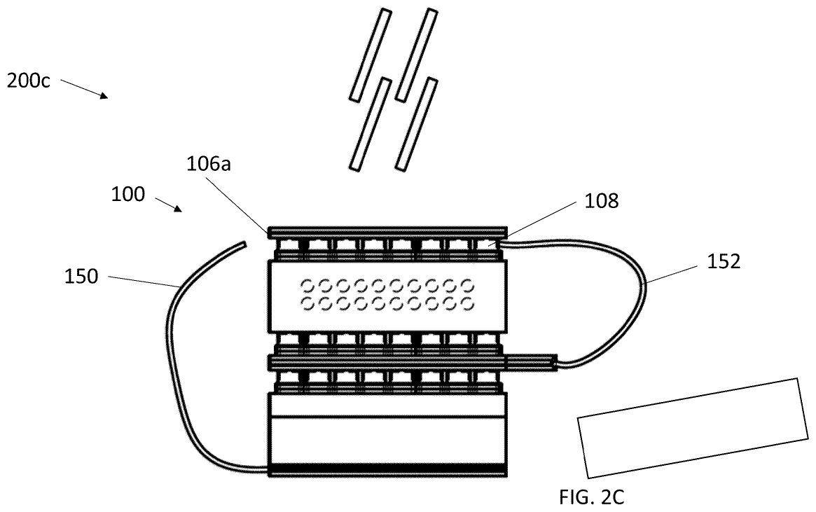

FIGS. 2A-2C show an apparatus in different states.

FIG. 2A is a side view, shown partly in phantom, of the apparatus 100 for converting and storing photonic energy as electrical energy in an initial state 200a. As shown in the example, an initial state 200a can include a first electrical pathway 150 disconnected from a transparent conductive oxide layer 106a and an external circuit 152 disconnected from an electrode layer 108.

FIG. 2B is a side view, shown partly in phantom, of the apparatus 100 for converting and storing photonic energy as electrical energy in a second state 200b. As shown in the example, a second state 200b can include a first electrical pathway 150 connected to a transparent conductive oxide layer 106a and an external circuit 152 disconnected from an electrode layer 108.

When incident sunlight shines on an upper surface of upper layer 102a of glass and passes through upper layer 102a of glass, electric fields are formed in the perovskite solar cell. First electrical pathway 150 can be connected in this second state and thereby allow for electron injection into the WO₃ cathode. Under the influence of the electric field, the H+260a transfers to the ESC cathode and a reaction occurs, whereby charges are stored at the WO₃ cathode according to WO₃+H++c->HWO₃. Also, under the influence of the electric field, SO₄ 260b moves to the ESC anode, balancing the charge.

FIG. 2C is a side view, shown partly in phantom, of the apparatus for converting and storing photonic energy as electrical energy in a third state 200c. As shown in the example embodiment, a third state 200c can include a first electrical pathway 150 disconnected from a transparent conductive oxide layer 16a4 and external circuit 152 connected to electrode layer 108.

Disconnection of first external circuit 250 from conductive oxide layer 204 stops electron injection. Connection of second external circuit 252 to electrode 208 allows for discharging the PVCS. Discharging results in the reverse reaction of HWO3->WO₃+H++c, and the ions are released, thereby allowing the apparatus to be in condition or otherwise ready for another charging cycle.

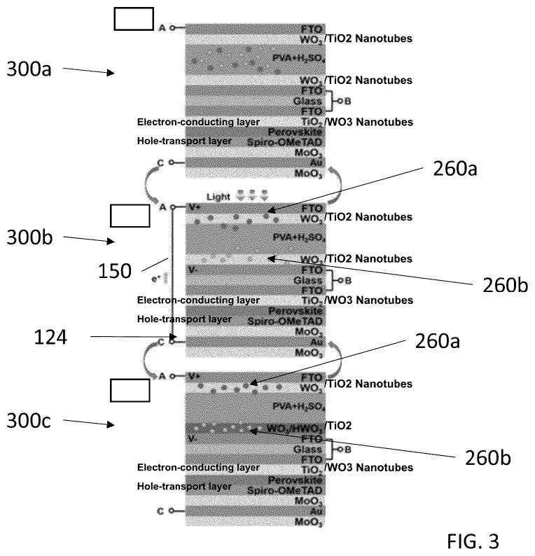

FIG. 3 is a diagram showing the apparatus for converting and storing photonic energy as electrical energy in different states. As shown, an initial state 300a can include H+260a and SO₄ 260b generally mixed in the quasi-solid electrolyte 112. In a second state 300b with incident solar energy, under influence of the electric field induced, the H+260a transfers to the ESC cathode and a reaction occurs, whereby charges are stored at the WO₃ cathode according to WO₃+H++c->HWO₃. Also, under the influence of the electric field, SO₄ 260b moves to the ESC anode, balancing the charge. Electrons are able to move along connected first electrical pathway 150 and charge storage occurs via MAM electrode 124. In a third state 300c, a first electrical pathway 150 can be disconnected and charge is stored. H+260a and SO₄ 260b generally remain in their mostly separated state until a discharge event occurs, for instance by connecting and/or activating an external circuit.

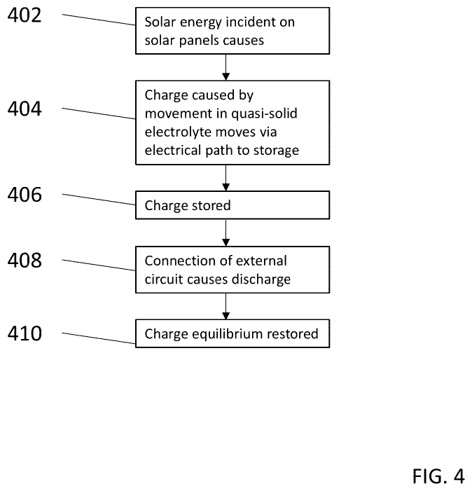

FIG. 4 is a flow diagram illustrating a method in accordance with an aspect of the present disclosure. As shown, in an initial step 402, electrical charge can be generated in an integrated solar panel generator and storage apparatus. If an electrical path is connected, in step 404 electrical charge that is generated via movement of ions in quasi-solid electrolyte can cause the charge to move along the electrical path and to be stored in a WO₃ cathode. In step 406, charge can be stored in the supercapacitor. When an external circuit is electrically coupled with the supercapacitor in step 408, discharge can occur. This means that the charge is being moved out of the apparatus for use elsewhere via the external circuit. In some aspects this could be for local use in a locally connected external circuit. In some aspects the external circuit could also be coupled with a grid and provide an injection of charge if and when needed. In some aspects, upon discharge, charge equilibrium can be restored in step 410, whereby chargeability is restored via additional incident solar rays.

In some aspects, electrical paths (e.g., electrical pathway 150) and/or external circuit (e.g., external circuit 152) can be manually, automatically, and/or semi-automatically electrically coupled and/or decoupled. These may be accomplished via physical couplings such as mechanical couplings, switches, or the like, and/or may be accomplished via electrical and/or chemical means. Automated and/or semi-automated electrical coupling mechanisms can be controlled via processor(s) and/or logic.

It should be understood that additional features and/or components can be included in various aspects. For example, one or more safety features can sense and/or monitor one or more safety conditions in the apparatuses and systems and may provide switches, alarms, interrupts, disconnects, and/or other features that mitigate, alleviate, prevent, notify, and/or otherwise relate to safety measures such as fires, overheating, or other potential dangers.

In some aspects, features that are included may be beneficial in that they improve the functionality of the apparatuses and systems. For example, one or more automated sensors can be provided that are coupled with a processor and/or logic that improves the angle at which the solar panel is oriented in order to maximize solar energy exposure. As such, the solar panel may be constantly, frequently, and/or periodically adjusted in order to maintain a generally perpendicular orientation with incident solar rays as the sun tracks across the sky.

In some aspects, one or more indicators can be included. Such indicators can be visual, audio, audiovisual, and/or others and may indicate many conditions related to the apparatuses and systems. For example, a visual indicator such as an LED, LCD screen, display, or other indicator could be employed to indicate that the apparatus is in operable condition. Alternatively or additionally, a visual indicator could indicate that maintenance is required, that a fault has been registered, that the system is operating properly, that a warning has been triggered, that the apparatus has malfunctioned and/or many others, as appropriate.

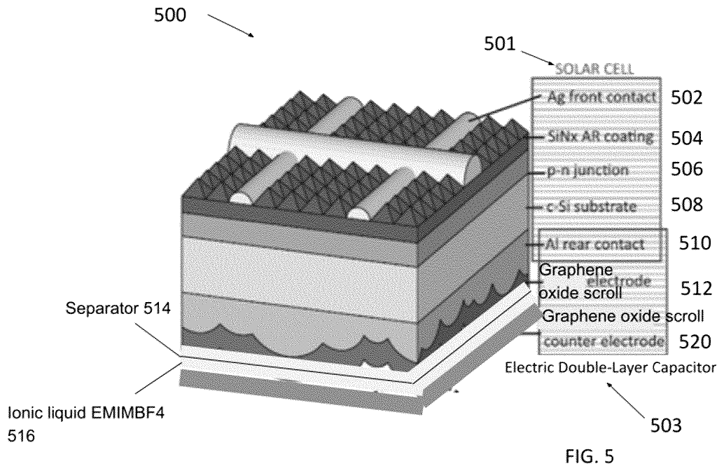

FIG. 5 shows a perspective view of an example apparatus for converting and storing photonic energy as electrical energy according to aspects herein. As shown, a solar cell 501 can be integrated with an electric double layer capacitor 503. The solar cell can include one or more front contacts that comprise silver, which can be laid out in a grid. A silicon nitride argon coating 504 can be over a p-n junction 506, which is in turn on a cesium iodide substrate 508. An aluminum rear contact 510 can be an interface between the solar cell 501 and electric double layer capacitor 503. The electric double layer capacitor 503 can further include a graphene oxide scroll electrode 512 separated by a separator 514 and ionic liquid 1-ethyl-3-methylimidazolium tetrafluoroborate 516, from another graphene oxide scroll counter electrode 520.

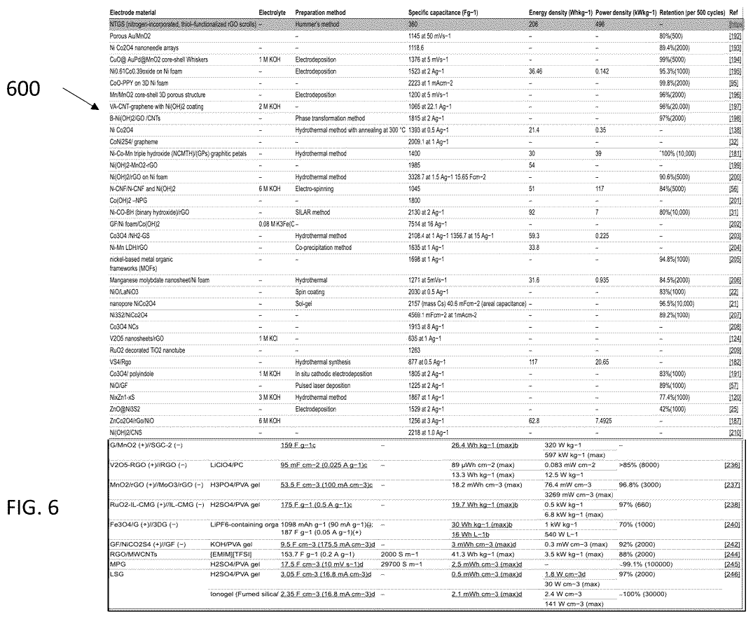

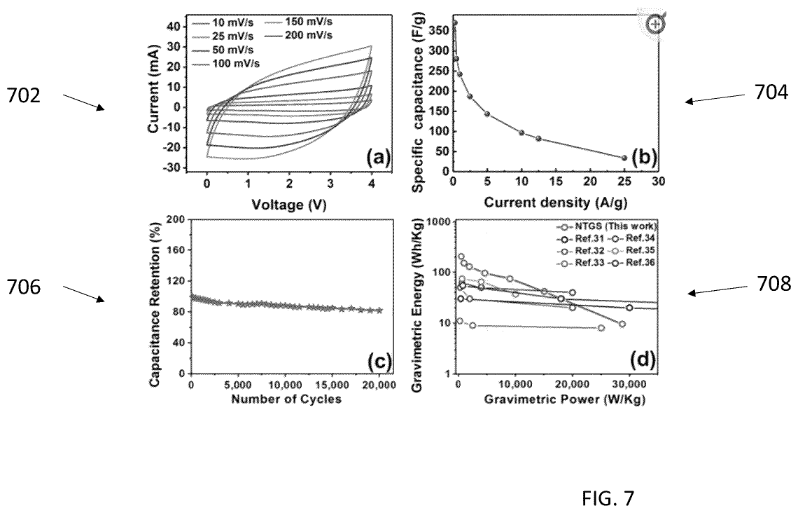

Due to its high specific surface area, graphene can be efficient in storing electrostatic charges. This allows graphene to be beneficial when used in supercapacitor electrodes. Graphene has a high power density, high charge and discharge rate, and a long cycle life. As shown in FIG. 6, other materials may not provide the same benefits as graphene as used in NTGS electrodes. Because NTGS uses a three dimensional, interconnected, continuous and porous structure, which maximizes surface area and minimizes pore size distribution, NTGS has clear and accessible ion and electrolyte channels. Restacking is also prevented because the bond between sulfur and hydrogen is greater than the van der Waals force that attracts neighboring rGO sheets. NTGS performance can be seen in FIG. 7.

In some aspects, manufacturing an integrated portion of a cell can include supercapacitor electrode deposition on an aluminum sheet. A uniform and stable suspension in water containing 0.5 mg mL−1 of GO nanotubes can be obtained. Next a piece of well cleaned aluminum (e.g., pure aluminum (99.9%)) and having a relatively small thickness (e.g., about 0.4 cm) can be cut (e.g., into 2 to 3 cm2 coupons) and can be used as cathode (i.e., negative electrode). Next, a copper plate can be used as an anode (i.e., positive electrode) vertically to form a parallel plate with a separation of about 10 mm. Before a treatment, the aluminum surface can be polished with 800, 1000, and 1200 SiC emery paper and then cleaned by ultrasonication bath in acetone (e.g., for about 10 minutes), and finally rinsed (e.g., with DI water). EPD can be carried out at 30 V using a DC voltage source at room temperature. Under an applied voltage, the GO plates can migrate toward the cathode, Al. After EPD (e.g., for about 3 min), the GO deposited samples can be withdrawn from the solution and dried at room temperature overnight.

FIG. 6 shows a chart 600 of supercapacitor materials and characteristics. It should be understood that in various aspects, solar cells can comprise one or more of Monocrystalline Silicon, Perovskite, III-V Semiconductor structures, Thin-film structures such as Amorphous Silicon, Copper-Indium Gallium Diselenide, Cadmium Telluride, Dye-Sensitized solar cells, organic solar cells, and graphene solar cells.

FIG. 7 shows a number of charts for supercapacitor performance characteristics. As shown, A first chart 702 can show cyclic voltammetry (CV) curves from 10-200 mV/s. A second chart 704 can show specific capacitances of a cell as a function of current density. A third chart 706 can show cycling performance of a cell. A fourth chart 708 can show Ragone plots of cells, compared with other supercapacitors.

Aspects herein include systems that reduce current energy losses of photolatics storage models by combining photovoltaics and storage into one unit. Higher volumetric and gravimetric energy densities are provided, in comparison to a solar power system built with separate components. These systems also require less wiring and are able to share electrodes by design. These systems reduce required space constraints, are easier to handle, and can have higher efficiency. These systems can be best suited for applications that require a short load cycle and high reliability. Batteries are unequipped to handle brief high load currents, and deteriorate faster when being used for this purpose.

The PV part converts incident light into electrical energy generating hole-electron pairs while promoting electrons to high-energy levels and leaving holes at low-energy levels. Excited electrons accumulate at one side (electrode) of the capacitor and holes in the other electrode until the capacitor saturates.

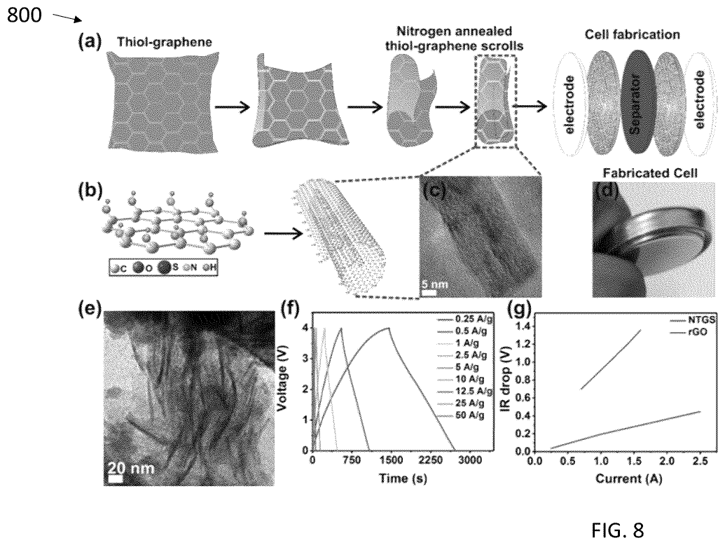

FIG. 8 shows a chart 800 of supercapacitor design and data. To make thiol-functionalized rGO scrolls, the reduced graphene oxide must be prepared using a modified Hummer's method. This can include a dialysis process (e.g., for two weeks), an overnight dry (e.g., at 90° C.), a mix with an agate mortar (e.g., for 30 minutes), and an annealing (e.g., at 800° C.) in ambient nitrogen (e.g., for an hour). Thiol functionalized rGO powder may then be dispersed (e.g., in 30 mL of water), suspended via sonication (e.g., for 8 hours), and centrifuged (e.g., at 12,000 rpm for 15 minutes). This process may require multiple repetitions. Using ethanol, a slurry of (e.g., 80%) active materials (NTGS or rGO), 10% Ketzen black, and 10% teflonized acetylene black), must be pressed on a nickel mesh current collector (e.g., with a 200 mm² area). It must then be dried (e.g., at 160° C. for 5 hours) in a vacuum oven. Finally, the supercapacitor must be assembled with symmetrical cell geometry, and fabricated with an ionic liquid EMIMBF4 electrolyte. The deposition on an aluminum sheet requires a uniform and stable suspension in water containing (e.g., 5 mg mL¹I of GO) nanotubes. A piece of well cleaned pure aluminum (e.g., 99.9%) thickness (e.g., 0.4 cm (cut into 2*3 cm₂ coupons)) can be used as a cathode, and a copper plate can be used as an anode vertically, forming a separation (e.g., of 10 mm). Before the treatment, the Aluminum surface is polished with (e.g., 800, 1000, and 1200 siC) emery paper and cleaned by ultrasonication bath in acetone (e.g., for 10 minutes) before being rinsed with Di water. After EOD was carried out at (e.g., 30 V) using a DC voltage source at room temperature, the plates migrated toward the cathode. After EPD (e.g., for 3 minutes), the GO deposited samples can be withdrawn from the solution and were all dried at room temperature overnight. FIG. 8 shows this setup and some related data.

In some aspects, one or more monitoring systems can be wirelessly and/or physically coupled with the systems and/or apparatuses. As such, status and/or performance can be monitored and repairs, upgrades, and/or replacements can be performed efficiently.

In some aspects, various possible supercapacitor and photovoltaic cell integration structures can be implemented. Planar structures can include two-electrode mode and three-electrode mode. Two components can be connected in series within the planar structure. One or more solar cell can be positioned at an upper area to receive and capture light/illumination shining on an upper surface. One or more supercapacitor can be placed at the bottom of the device. In some aspects, a DSSC-integrated supercapacitor can demonstrate higher efficiency with three electrodes compared to two-electrode mode. Two-electrode mode can have features such as electron transfer challenges across TiO2 layer, leading to device self-discharge and increased resistance. Thus, an additional electrode, can be added to separate DSSC and supercapacitor, acting as a barrier and redox electron transfer surface for improved charge storage. PEDOT-carbon electrode used to bridge supercapacitor and perovskite solar cell. In some aspects, a device achieved maximum overall efficiency of 4.70% with energy storage efficiency of 73.77%. Planar structures, despite rapid progress, can sometimes face limitations in portable electronics due to their rigid connection.

In a fiber structure implementation, fiber structure shares principles with planar design but differs in component arrangement (coaxial, parallel-like, twisted). Fiber shape less efficient and complex to fabricate but suitable for wearable devices with low-power needs, leveraging favorable mechanical properties.

Integration of a solar panel and supercapacitor can be ultimately achieved through a common electrode. This setup can demonstrate higher volumetric and gravimetric energy densities compared to separate solar power systems. Further, this can achieve reduced size (i.e., greater compactness) due to its streamlined structure, reduced wiring, and shared electrodes. Additionally, it eliminates space constraints and offers increased case of handling. Moreover, integration shows improved efficiency and is particularly suitable for applications requiring short load cycles and high reliability. Supercapacitors can be favored over batteries in integrated devices due to their high power density. This allows and enables more energy delivery in a short time. Unlike batteries, supercapacitors are resilient to deterioration caused by high load currents and instantaneous power demands, leading to elevated discharge rates and currents.

Various supercapacitor configurations can be implemented in different aspects. These can include electric double-layer capacitors that enable storing charge at the surface electrode through reversible ion absorption/desorption to form an electrical double-layer capacitance. Pscudocapacitors and hybrid capacitors can also be included in some aspects.

Graphene oxide can be deposited on an aluminum surface in various methods, including spin coating, chemical vapor deposition (CVD), electrophoretic deposition (EPD), dip coating, polymeric composite, and others.

Various alternate supercapacitor electrode materials can include one or more of Porous Au/MnO2, Ni Co2O4 nanoneedle arrays, CuO@ AuPd@MnO2 core-shell Whiskers, Ni0.61Co0.39oxide on Ni foam, CoO-PPY on 3D Ni foam, Mn/MnO2 core-shell 3D porous structure, VA-CNT-graphene with Ni(OH)2 coating, B—Ni(OH)2/GO/CNTs, Ni Co2O4, CoNi2S4/graphene, Ni—Co—Mn triple hydroxide (NCMTH)/(GPs) graphitic petals, Ni(OH) 2-MnO2-rGO, Ni(OH) 2/rGO on Ni foam, N—CNF/N—CNF and Ni(OH) 2, Co(OH) 2-NPG, Ni—CO—BH (binary hydroxide)/rGO, GF/Ni foam/Co(OH) 2, Co3O4/NH2-GS, Ni—Mn LDH/rGO, nickel-based metal organic frameworks (MOFs), Manganese molybdate nanosheet/Ni foam, NiO/LaNiO3, nanoporc NiCo2O4, Ni3S2/NiCo2O4, Co3O4 NCs, V205 nanosheets/rGO, RuO2 decorated TiO2 nanotube, VS4/Rgo, Co304/polyindole, NiO/GF, NixZn1-xS, ZnO@Ni3S2, ZnCo2O4/rGo/NiO, and/or Ni(OH)2/CNS.

Various alternate supercapacitor electrolyte materials can include one or more of [EMIM][BF4], [Li][TFSI]/AN, H2SO4, KOH, [TBA][PF6]/AN, [BMIM][BF4]/AN, KOH/PVA gel, H2SO4/PVA gel, H3PO4/PVA gel, Ionogel (Fumed silica/[BMIM][TFSI]), LiPF6-containing organic electrolyte, LiClO4/PC

All of the apparatus, methods, and algorithms disclosed and claimed herein can be made and executed without undue experimentation in light of the present disclosure. While the aspects have been described in terms of preferred features, it will be apparent to those having ordinary skill in the art that variations may be applied to the apparatus, methods and sequence of steps of the method without departing from the concept, spirit and scope of the disclosure. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the disclosure as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed aspects. While the foregoing disclosure discusses illustrative aspects and/or features, it should be noted that various changes and modifications could be made herein without departing from the scope of the described aspects and/or features as defined by the appended claims. Furthermore, although elements of the described aspects and/or features may be described or claimed in the singular, the plural is contemplated unless limitation to the singular is explicitly stated. Additionally, all or a portion of any aspect and/or feature may be utilized with all or a portion of any other aspect and/or feature, unless stated otherwise.

What is claimed is:

1. An integrated apparatus for generating and storing electricity, comprising:
one or more photovoltaic electricity generators; and
one or more supercapacitors,
wherein the one or more supercapacitors are configured to be deposited on the one or more photovoltaic electricity generators for electrical charge storage.

2. The apparatus of claim 1, wherein the one or more supercapacitors are directly deposited on the photovoltaic electricity generator.

3. The apparatus of claim 1, wherein the one or more supercapacitors further comprise one or more electrodes and the one or more photovoltaic electricity generators further comprise one or more conductive layers.

4. The apparatus of claim 3, wherein there is a path for electron flow between the electrode of the one or more supercapacitors and the one or more conductive layers of the photovoltaic electricity generators.

5. The apparatus of claim 1, wherein the photovoltaic electricity generator further comprises one or more solar cell.

6. The apparatus of claim 5, wherein the one or more solar cell comprises silicon or other materials.

7. The apparatus of claim 1, wherein the one or more supercapacitors further comprise nanotube structures.

8. The apparatus of claim 7, wherein the nanotube structures further comprise reduced graphene oxide or other materials.

9. The apparatus of claim 1, wherein the one or more supercapacitors further comprise one or more dual layer supercapacitors.

10. The method of claim 1, wherein the one or more photovoltaic electricity generators and the one or more supercapacitors are integrated.

11. A method of generating and storing electricity using an integrated solar cell, comprising:
generating electrical charge via one or more photovoltaic electricity generators;
selectively allowing electrical flow to one or more electrochromic supercapacitors; and
storing the generated electrical charge via one or more supercapacitors.

12. The method of claim 11, wherein selectively allowing electrical flow is performed automatically.

13. The method of claim 11, wherein selectively allowing electrical flow requires input from a user.

14. The method of claim 11, wherein selectively allowing flow further comprises the connecting one or more conductive layers of the one or more photovoltaic electricity generators to the one or more supercapacitors.

15. The method of claim 14, wherein selectively allowing flow further comprises connecting one or more conductive layers of the one or more photovoltaic electricity generators to one or more electrodes of the one or more supercapacitors.

16. The method of claim 11, further comprising:
discharging the one or more supercapacitors.

17. The method of claim 16, wherein discharging the one or more supercapacitors further comprises selectively connecting one or more electrodes of the one or more supercapacitors to an external circuit.

18. The method of claim 11, wherein generating electrical charge via one or more photovoltaic electricity generators further comprises generating electrical charge using one or more solar cell.

19. The method of claim 18, wherein the solar cell further comprises silicon or other materials.

20. The method of claim 11, wherein the one or more supercapacitors further comprise nanotube structures.
